(19) United States
(12) Patent Application Publication
(10) Pub. No.: US 2024/0157748 A1
(43) Pub. Date: May 16, 2024

(54) Vehicle And Method Of Controlling The Same

(71) Applicants: Hyundai Motor Company, Seoul (KR); Kia Corporation, Seoul (KR)

(72) Inventors: Untae Kim, Suwon-Si (KR); Deukyoung Jung, Suwon-Si (KR)

(21) Appl. No.: 18/233,527

(22) Filed: Aug. 14, 2023

(30) Foreign Application Priority Data
Nov. 15, 2022 (KR) 10-2022-0152803

(51) Int. Cl. B60G 17/0165

(52) U.S. Cl. CPC B60G 17/0165; B60G 2400/20; B60G 2400/80; B60G 2500/10

(57) ABSTRACT

A vehicle according to one or more embodiments of the present disclosure include a camera having a surrounding field of view of a host vehicle and configured to obtain image data, a plurality of suspensions provided at a corresponding wheel of the host vehicle, a controller electrically connected to the plurality of suspensions and comprising one or more processors and memory. The memory stores instructions that, when executed by the one or more processors, cause the controller to: determine, based on the image data, a position, relative to the host vehicle, of an overtaking vehicle overtaking the host vehicle, and control, based on the position of the overtaking vehicle, a damping force of at least one of the plurality of suspensions.

### CROSS-REFERENCE TO RELATED APPLICATION(S)

This application claims the benefit of Korean Patent Application No. 10-2022-0152803, filed on Nov. 15, 2022, which application is hereby incorporated herein by reference.

### TECHNICAL FIELD

The present disclosure relates to a vehicle configured for improving driving stability of a vehicle by controlling suspensions provided in the vehicle, and a method of controlling the same.

### BACKGROUND

Generally, when a trailing vehicle quickly overtakes a host vehicle (e.g., a leading vehicle) on a highway, the host vehicle may shake significantly from side to side. This is caused by the overtaking vehicle pushing through air rapidly and creating a high-pressure area in front of the overtaking vehicle and a low-pressure area behind. In other words, the sudden change in air pressure caused by the overtaking vehicle may cause the host vehicle to shake.

In some cases, a host vehicle driving in a straight line may experience unstable vehicle behavior, such as leaning in a lateral direction regardless of an intention of a driver. As a result, ride comfort and straight-line driving stability of a vehicle may be deteriorated.

### SUMMARY

The present disclosure provides a vehicle configured for improving ride comfort and straight-line driving stability of the vehicle by predicting left and right shaking of a host vehicle due to surrounding vehicles approaching the host vehicle and reducing or minimizing the left and right shaking of the host vehicle using suspension control, and a method of controlling the same.

Additional features will be set forth in part in the description which follows and, in part, will be obvious from the description, or may be learned by practice of the disclosure.

According to one of more example embodiments of the present disclosure, a host vehicle may include: a camera having a surrounding field of view of the host vehicle and configured to obtain image data; a plurality of suspensions, wherein each suspension of the plurality of suspensions is provided at a corresponding wheel of the host vehicle; and a controller electrically connected to the plurality of suspensions and comprising: one or more processors; and memory. The memory may store instructions that, when executed by the one or more processors, cause the controller to: determine, based on the image data, a position, relative to the host vehicle, of an overtaking vehicle overtaking the host vehicle; and control, based on the position of the overtaking vehicle, a damping force of at least one of the plurality of suspensions.

The position may include one of an entry zone, a parallel zone, or an exit zone.

The at least one of the plurality of suspensions may correspond to one of the entry zone, the parallel zone, or the exit zone.

The instructions, when executed by the one or more processors, may cause the controller to control the damping force of the at least one of the plurality of suspensions by increasing, based on the position of the overtaking vehicle being the entry zone, a damping force of one or more suspensions, of the host vehicle, on a far side of the host vehicle relative to the overtaking vehicle.

The instructions, when executed by the one or more processors, may cause the controller to control the damping force of the at least one of the plurality of suspensions by gradually reducing, based on the position of the overtaking vehicle being at a back of the parallel zone, a damping force of one or more suspension, of the host vehicle, on a far side of the host vehicle relative to the overtaking vehicle.

The instructions, when executed by the one or more processors, may cause the controller to control the damping force of the at least one of the plurality of suspensions by performing, based on the position of the overtaking vehicle being at a back of the parallel zone and further based on a following distance between the host vehicle and the overtaking vehicle, a steering control or speed control of the host vehicle.

The instructions, when executed by the one or more processors, may further cause the controller to, based on the following distance being greater than a threshold distance, steer the host vehicle toward the overtaking vehicle.

The instructions, when executed by the one or more processors, may further cause the controller to, based on the following distance being less than or equal to a threshold distance, increase a speed of the host vehicle within a preset speed range relative to a speed of the overtaking vehicle.

The instructions, when executed by the one or more processors, may cause the controller to control the damping force of the at least one of the plurality of suspensions by increasing, based on the position of the overtaking vehicle being at a front of the parallel zone, a damping force of one or more suspensions, of the host vehicle, on a near side of the host vehicle relative to the overtaking vehicle.

The instructions, when executed by the one or more processors, may cause the controller to control the damping force of the at least one of the plurality of suspensions by increasing, based on the position of the overtaking vehicle being at the exit zone, a damping force of one or more suspensions, of the host vehicle, on a far side of the host vehicle relative to the overtaking vehicle.

The instructions, when executed by the one or more processors, may cause the controller to control the damping force of the at least one of the plurality of suspensions by adjusting the damping force of the at least one of the plurality of suspensions based on at least one of: a body type of the host vehicle, or an overall height of the overtaking vehicle.

The body type of the host vehicle may include at least one of: a notchback type, a fastback type, or a hatchback type.

The instructions, when executed by the one or more processors, may cause the controller to control the damping force of the at least one of the plurality of suspensions by controlling, based on the body type of the host vehicle being the hatchback type, the damping force of the at least one of the plurality of suspensions to be higher than for the notchback type and for the fastback type.

The damping force of the at least one of the plurality of suspensions may have a positive correlation with respect to the overall height of the overtaking vehicle.

According to one or more example embodiments of the present disclosure, a method may include: obtaining, via a camera, image data on surroundings of a host vehicle; determining, by one or more processors and based on the image data, a position, relative to the host vehicle, of an overtaking vehicle overtaking the host vehicle; and controlling, by the one or more processors and based on the position of the overtaking vehicle, a damping force of at least one of a plurality of suspensions of the host vehicle. Each suspension of the plurality of suspensions may be provided at a corresponding wheel of the host vehicle.

The position may include one of an entry zone, a parallel zone, or an exit zone.

Controlling of the damping force of the at least one of the plurality of suspensions may include: based on the position being one of the entry zone or the exit zone, increasing a damping force of one or more suspensions, of the host vehicle, on a far side of the host vehicle relative to the overtaking vehicle.

Controlling of the damping force of the at least one of the plurality of suspensions may include, based on the position of the overtaking vehicle being at a back of the parallel zone: gradually reducing a damping force of one or more suspensions, of the host vehicle, on a far side of the host vehicle relative to the overtaking vehicle; and performing, further based on a following distance between the host vehicle and the overtaking vehicle, a steering control or speed control of the host vehicle.

Controlling of the damping force of the at least one of the plurality of suspensions may include: adjusting the damping force of the at least one of the plurality of suspensions based on at least one of: a body type of the host vehicle, or an overall height of the overtaking vehicle.

The body type of the host vehicle may include at least one of: a notchback type, a fastback type, or a hatchback type. Controlling of the damping force of the at least one of the plurality of suspensions may include: controlling, based on the body type of the host vehicle being the hatchback type, the damping force of the at least one of the plurality of suspensions to be higher than for the notchback type and for the fastback type.

### BRIEF DESCRIPTION OF THE DRAWINGS

These and/or other aspects of the disclosure will become apparent and more readily appreciated from the following description, taken in conjunction with the accompanying drawings, in which:

FIG. 1 is a control block diagram illustrating a vehicle;

FIG. 2 is a view illustrating a camera and radar included in a vehicle;

FIG. 3 is a view illustrating a suspension included in a vehicle;

FIG. 4 is a flowchart illustrating a method for controlling a vehicle;

FIG. 5 is a view illustrating drag difference according to relative positions between a vehicle and an overtaking vehicle;

FIG. 6 is a view illustrating lateral force and yaw moment according to relative positions between a vehicle and an overtaking vehicle;

FIG. 7 is a view illustrating a suspension control for each overtaking section between a vehicle and an overtaking vehicle;

FIG. 8 is a view illustrating a suspension control when a following distance between a vehicle and an overtaking vehicle is sufficient;

FIG. 9 is a view illustrating a suspension control when a following distance between a vehicle and an overtaking vehicle is insufficient;

FIG. 10 is a view illustrating a suspension control based on a vehicle body type and an overall height of an overtaking vehicle;

FIG. 11 is a graph showing lateral force for each vehicle body type; and

FIG. 12 is a graph showing a lateral force applied to a host vehicle according to an overall height of an overtaking vehicle.

### DETAILED DESCRIPTION

Reference will now be made in detail to various examples of the disclosure. Examples of which are illustrated in the accompanying drawings, wherein like reference numerals refer to like elements throughout. This specification may not describe all elements of the disclosed embodiment(s) and detailed descriptions of what is well known in the art or redundant descriptions on substantially the same configurations may be omitted. The terms ‘part’, ‘module’, ‘member’, ‘block’ and the like as used in the specification may be implemented in software and/or hardware. Further, a plurality of ‘part’, ‘module’, ‘member’, ‘block’ and the like may be embodied as one component. It is also possible that one ‘part’, ‘module’, ‘member’, ‘block’ and the like includes a plurality of components.

Throughout the specification, when an element is referred to as being “connected to” another element, it may be directly or indirectly connected to the other element and the “indirectly connected to” includes being connected to the other element via a wireless communication network.

Also, it is to be understood that the terms “include” and “have” are intended to indicate the existence of elements disclosed in the specification, and are not intended to preclude the possibility that one or more other elements may exist or may be added.

Throughout the specification, when a member is located “on” another member, this includes not only when one member is in contact with another member but also when another member is present between the two members.

The terms first, second, and the like are used to distinguish one component from another component, and the component is not limited by the terms described above.

An expression used in the singular encompasses the expression of the plural, unless it has a clearly different meaning in the context.

The reference numerals used in operations are used for descriptive convenience and are not intended to describe the order of operations and the operations may be performed in a different order unless otherwise stated.

Hereinafter, various examples of the present disclosure will be described in detail with reference to the accompanying drawings.

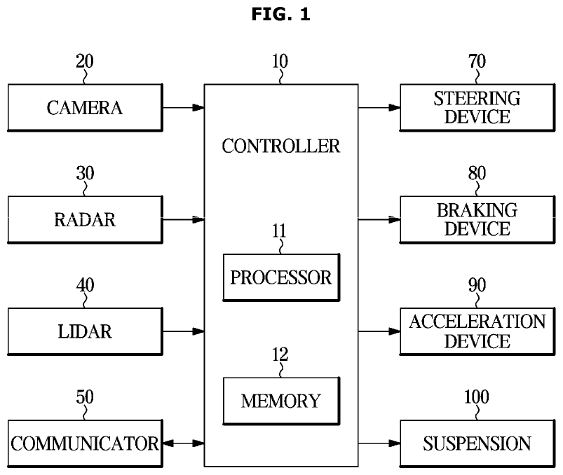

FIG. 1 is a control block diagram showing a vehicle.

Referring to FIG. 1, a vehicle 1 may include a controller 10 that performs overall control of the vehicle.

The controller 10 may be electrically connected to a camera 20, a radar 30, a light detection and ranging (LiDAR) 40, and a communicator 50. The vehicle 1 is not limited to that shown in FIG. 1. For example, in the vehicle 1 shown in FIG. 1, at least one detecting means of the camera 20, the radar 30, and LiDAR 40 may be omitted or various detecting means for detecting an object around the vehicle 1 may be further included.

The controller 10, the camera 20, the radar 30, and the LiDAR 40 may be provided separately from each other. For example, the controller 10 may be disposed in a different housing separated from a housing of the camera 20, the housing of the radar 30, and a housing of the LiDAR 40. The controller 10 may exchange data with the camera 20, the radar 30, and/or the LiDAR 40 via a wide-bandwidth network.

At least some of the controller 10, the camera 20, the radar 30, and LiDAR 40 may be provided integrally. For example, the camera 20 and the controller 10 are disposed in one housing, the radar 30 and the controller 10 are disposed in one housing, or the LiDAR 40 and the controller 10 may be disposed in one housing.

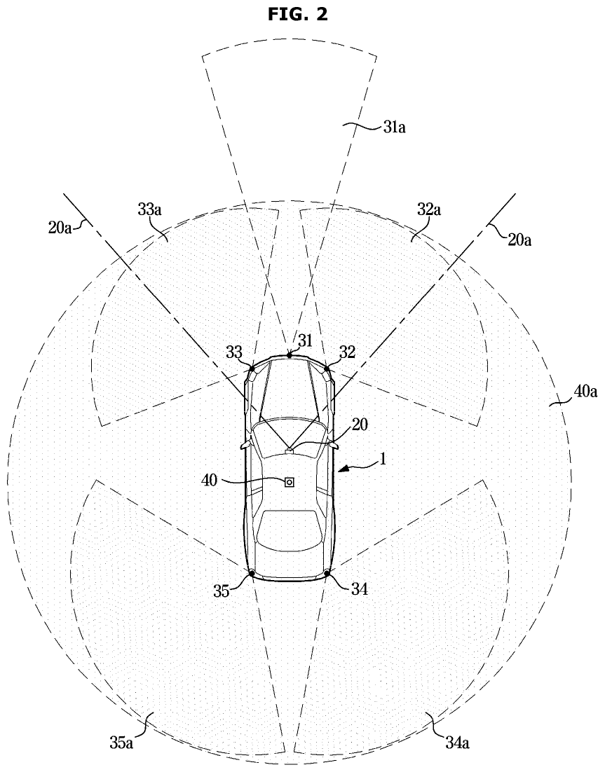

The camera 20 may photograph surroundings of the vehicle 1 and acquire image data of the surroundings of the vehicle 1. For example, as shown in FIG. 2, the camera 20 may be installed on a front windshield of the vehicle 1 and may be a front camera with a field of view 20a facing in front of the vehicle 1.

The camera 20 may include a plurality of lenses and image sensors. The image sensor may include a plurality of photodiodes that convert light into electrical signals, and the plurality of photodiodes may be arranged in a two-dimensional matrix.

The image data may include information regarding other vehicles or pedestrians or cyclists or lanes located around the vehicle 1.

The vehicle 1 may include an image processor that processes image data of the camera 20, and the image processor may be provided for example, integrally with the camera 20 or integrally with the controller 10.

The image processor may obtain image data from the image sensor of the camera 20 and detect and identify objects around the vehicle 1 based on a processing of the image data. For example, the image processor may create tracks representing objects around the vehicle 1 using image processing, and then classify the tracks. The image processor may identify whether the track is any other vehicles, or a pedestrian, a cyclist, or the like, and assign an identification code to the track.

The image processor may transmit data on the tracks around the vehicle 1 (or location and classification of the tracks) (hereinafter referred to as camera tracks) to the controller 10.

The radar 30 may transmit radio waves toward surroundings of the vehicle 1 and detect surrounding objects of the vehicle 1 based on reflected radio waves reflected from the surrounding objects.

The radar 30 may include a transmission antenna (or transmission antenna array) for radiating transmitted radio waves toward the surroundings of the vehicle 1 and a reception antenna (or reception antenna array) for receiving reflected radio waves reflected on objects.

The radar 30 may obtain radar data from transmitted radio waves sent by a transmission antenna and reflected radio waves received by a reception antenna. The radar data may include location information (e.g., distance information) and/or a degree of speed of objects located in front of the vehicle 1.

For example, as shown in FIG. 2, the radar 30 may include a front radar 31 and a plurality of corner radars 32, 33, 34, and 35.

The front radar 31 may transmit forward detecting data toward a front center of the vehicle 1 (hereinafter referred to as front detecting data) to the controller 10. For example, the front radar 31 may be disposed in a center of a front bumper of the vehicle 1.

The plurality of corner radars 32, 33, 34, and 35 may include a first corner radar 32 disposed on a front right side of the vehicle 1, a second corner radar 33 disposed on a front left side of the vehicle 1, a third corner radar 34 disposed on a rear right side of the vehicle 1, and a fourth corner radar 35 disposed on a rear left side of the vehicle 1.

The first corner radar 32 may have a field of sensing 32a toward the front right side of the vehicle 1. For example, the first corner radar 32 may be installed on a right side of the front bumper of the vehicle 1. The second corner radar 33 may have a field of sensing 33a toward the front left side of the vehicle 1, and for example, may be installed on a left side of the front bumper of the vehicle 1. The third corner radar 34 may have a field of sensing 34a toward the rear right side of the vehicle 1, and for example, may be installed on a right side of a rear bumper of the vehicle 1. The fourth corner radar 35 may have a field of sensing 35a toward the rear left side of the vehicle 1, and for example, may be installed on a left side of the rear bumper of the vehicle 1.

The first, second, third, and fourth corner radars 32, 33, 34, and 35 may acquire first corner detection data, second corner detection data, third corner detection data, and fourth corner detection data, respectively. The first corner detection data may include distance information and a degree of speed of an object located on the front right side of the vehicle 1. The second corner detection data may include distance information and a degree of speed of an object located on the left front side of the vehicle 1. The third and fourth corner detection data may include distance information and relative speeds of objects located on the rear right side and the rear left side of the vehicle 1.

The first, second, third, and fourth corner radars 32, 33, 34, and 35 may transmit the first, second, third, and fourth corner detection data to the controller 10, respectively.

The vehicle 1 may include a signal processor that processes the radar data of the radar 30, and the signal processor may be provided for example, integrally with the radar 30 or integrally with the controller 10.

The signal processor may obtain radar data from the reception antenna of the radar 30 and generate a track representing an object by clustering reflection points of the reflected signals. The signal processor may obtain a distance of the track based on, for example, a time difference between a transmission time of the transmitted radio wave and a reception time of the reflected radio wave, and obtain a relative speed of the track based on a difference between a frequency of the transmitted radio wave and a frequency of the reflected radio wave.

The signal processor may transmit data on tracks around the vehicle 1 (or distance and relative speed of the track) obtained from radar data (hereinafter referred to as radar track) to the controller 10.

The LiDAR 40 may emit light (e.g., infrared rays) toward the surroundings of the vehicle 1 and detect surrounding objects around the vehicle 1 based on reflected light reflected from the surrounding objects. For example, as shown in FIG. 2, the LiDAR 40 may be disposed on a roof of the vehicle 1 and may have a field of view 40a in all directions around the vehicle 1.

The LiDAR 40 may include a light source (e.g., a light emitting diode (LED), a LED array, a laser diode (LD), or a LD array) that emits light (e.g., infrared light), and an optical sensor (e.g., a photodiode or photodiode array) that receives light (e.g., infrared light). In addition, if necessary, the LiDAR 40 may further include a driving device for rotating the light source and/or the optical sensor.

While the light source and/or the optical sensor rotates, the LiDAR 40 may emit light from the light source and receive light reflected from objects through the optical sensor, thereby acquiring LiDAR data.

The LiDAR data may include relative positions (distance and/or direction of the surrounding objects) and/or relative speeds of the surrounding objects of the vehicle 1.

The vehicle 1 may include a signal processor configured for processing LiDAR data of the LiDAR 40, and the signal processor is provided for example, integrally with the LiDAR 40 or integrally with the controller 10.

The signal processor may generate a track representing an object by clustering reflection points by reflected light. The signal processor may obtain a distance to the object based on, for example, a time difference between a light transmission time and a light reception time. In addition, the signal processor may obtain a direction (or angle) of the object with respect to a driving direction of the vehicle 1 based on a direction in which the light source emits light when the optical sensor receives the reflected light.

The signal processor may transfer data on tracks around the vehicle 1 (or distance and relative speed of the track) obtained from LiDAR data (hereinafter referred to as LiDAR track) to the controller 10.

The communicator 50 may include one or more components enabling communication with an external device, and may include, for example, a wireless internet module, a short-distance communication module, and an optical communication module. The wireless internet module refers to a module for wireless internet access, and may be installed in the vehicle either internally or externally. The wireless internet module may transmit and receive wireless signals in a communication network based on wireless internet technologies. Wireless internet technologies may include, such as a wireless local area network (WLAN), wireless-fidelity (Wi-Fi), Wi-Fi Direct, digital living network alliance (DLNA), wireless broadband (WiBro), world interoperability for microwave access (WiMAX), high speed downlink packet access (HSDPA), high speed uplink packet access (HSUPA), long term evolution (LTE), long term evolution-advanced (LTE-A), 5-generation (5G) networks, 6-generation (6G) networks, and the like. The short-distance communication module is for short-range communication, and may support short-distance communication using at least one of Bluetooth™, radio frequency identification (RFID), infrared data association (IrDA), ultra wideband (UWB), ZigBee, near field communication (NFC), Wi-Fi, Wi-Fi Direct, and wireless universal serial bus (USB) technologies. The optical communication module may include an optical transmitter and an optical receiver.

The communicator 50 may receive location and driving information of other vehicles around a host vehicle via vehicle-to-vehicle (V2X) wireless communication.

The controller 10 may be electrically connected to the camera 20, the radar 30, the LiDAR 40, and the communicator 50. In addition, the controller 10 may be connected to a steering device 70, a braking device 80, an acceleration device 90, and a suspension 100 via a communication network for vehicle (NT). The NT may be for example, Ethernet, media oriented systems transport (MOST), Flexray, controller area network (CAN), local interconnect network (LIN), or the like.

The controller 10 may process the camera track (or image data) of the camera 20, the radar track (or radar data) of the radar 30, and/or the LiDAR track (or LiDAR data) of the LiDAR 40, and may provide control signals to the steering device 70, the braking device 80, the acceleration device 90, and/or the suspension 100.

The controller 10 may include a processor 11 and a memory 12.

The memory 12 may store programs and/or data for processing image data, radar data, and/or LiDAR data. Furthermore, the memory 12 may store programs and/or data for generating steering/braking/acceleration/suspension signals.

The memory 12 may temporarily store image data received from the camera 20, radar data received from the radar 30, and LiDAR data received from the LiDAR 40, and may temporarily store the processing results of the image data of the processor 141, the radar data, and/or the LiDAR data.

The memory 12 may include not only a volatile memory, such as static-random access memory (S-RAM), dynamic-RAM (D-RAM), and the like, but also a non-volatile memory, such as, flash memory, read only memory (ROM), erasable programmable read only memory (EPROM), and the like.

The processor 11 may process the camera track of the camera 20, the radar track of the radar 30, and/or the LiDAR track of the LiDAR 40. For example, the processor 11 may fuse the camera track, the radar track, and/or the LiDAR track, and output a fusion track.

The processor 11 may include an image processor processing the image data of the camera 20, a signal processor processing the radar data of the radar 30 and/or the LiDAR data of the LiDAR 40, or a micro control unit (MCU) generating steering/braking/acceleration/suspension signals.

The controller 10 may provide, based on the image data of the camera 20, the radar data of the radar 30, the LiDAR data of the LiDAR 40, and/or the communication data of the communicator 50, the steering signal, the braking signal, the acceleration signal, and/or the suspension signal.

The steering device 70 may include an electronic power steering control module (EPS). The steering device 70 may change the driving direction of the vehicle 1, and the EPS may assist an operation of the steering device 70 so that a driver may easily operate a steering wheel in response to a driver's intention to steering through the steering wheel. In addition, the EPS may control the steering device in response to a request of the controller 10. For example, the EPS may receive a steering request including steering torque from the controller 10, and control the steering device to steer the vehicle 1 depending on the requested steering torque.

The braking device 80 stops the vehicle 1, and may include, for example, a brake caliper and an electronic brake control module (EBCM). The brake caliper may decelerate or stop the vehicle 1 by using friction with a brake disc, and the EBCM may control the brake caliper in response to a driver's intention to braking through a brake pedal and/or a request from the controller 10. For example, the EBCM may receive a deceleration request including a deceleration rate from the controller 10, and electrically or hydraulically control the brake caliper so that the vehicle 1 decelerates depending on the requested deceleration rate.

The acceleration device 90 moves the vehicle 1, and may include, for example, an engine, an engine management system (EMS), a transmission, and a transmission control unit (TCU). The engine may generate power for the vehicle 1 to drive, and the EMS may control the engine in response to a driver's intention to accelerate through an accelerator pedal or a request from the controller 10. The transmission may decelerate and transmit the power generated by the engine to wheels of the vehicle, and the TCU may control the transmission in response to a driver's instruction to shift through a shift lever and/or a request from the controller 10.

The suspension 100 may be disposed adjacent to wheels of front left (FL), front right (FR), rear left (RL), and rear right (RR) wheels.

The suspension 100 may be an electronically controlled suspension with variable damping force.

The suspension 100 may individually or independently control damping force for each wheel.

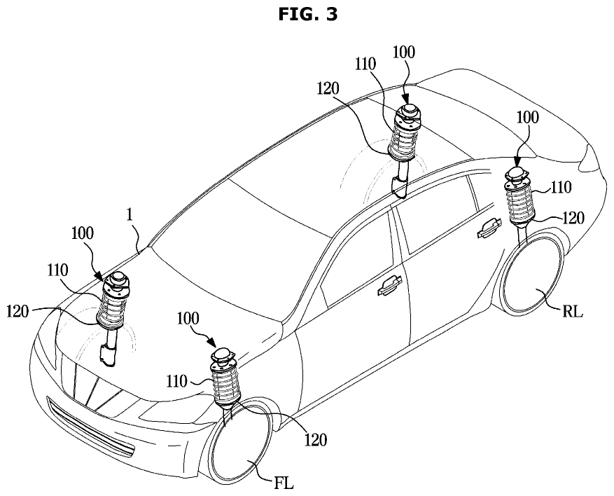

FIG. 3 is a view illustrating suspensions included in a vehicle.

Referring to FIG. 3, the suspension 100 is provided between each wheels FL, FR, RL, and RR of the vehicle 1 and a vehicle body.

The suspension 100 may include a spring 110 and a variable damper 120.

The spring 110 may reciprocate while compressing or tensioning according to conditions of a road surface.

The variable damper 120 is a damper capable of adjusting damping force. The controller 10 may control the damping force of the suspension 100 by controlling the variable damper 120.

The variable damper 120 may damp vibration generated by the spring 110 when the vehicle 1 passes an obstacle. In other words, the variable damper 120 may suppress the reciprocating motion of the spring 110 by providing a force in the opposite direction of the force generated by the spring 110. That is, the force that suppresses the movement of the spring 110 is so-called damping force. For example, the variable damper 120 may include a piston rod and a solenoid valve therein. The resistance generated in a process of fluid movement through the passage formed by the piston rod and the solenoid valve refers to a damping force. The variable damper 120 generates a damping force through a compression stroke and a rebound stroke. As the solenoid valve moves, the width of the passage, which is a fluid movement channel, is adjusted, and accordingly the damping force may be adjusted. The suspension 100 may control the damping force of the variable damper 120 based on a damping force control command and/or a damping force control signal that is a suspension signal input from the controller 10.

The variable damper 120 may continuously vary the damping force from a soft characteristic to a hard characteristic. The variable damper 120 may not necessarily be configured to vary the damping force continuously, but may be intermittently (or in stages) shifted in stage 1, stage 2, stage 3, and stage 4 or more. The more the damping force of the variable damper 120 increases, the harder the suspension 100 becomes, and the more the damping force of the variable damper decreases, the softer the suspension 100 becomes.

On the other hand, the controller 10 may receive detection information from a motion sensor that detects the motion of the vehicle 1. The motion sensor may acquire behavior data representing the movement of the vehicle 1. For example, the motion sensor may include a speed sensor for detecting a speed of a wheel, an acceleration sensor for detecting a lateral acceleration and longitudinal acceleration of the vehicle 1, a yaw rate sensor for detecting a yaw rate of the vehicle, a steering angle sensor for detecting a steering angle of a steering wheel, a torque sensor for detecting a steering torque of the steering wheel, and the like. The behavior data may include wheel speed, lateral acceleration, longitudinal acceleration, yaw rate, steering angle, steering torque, and the like.

As described above, while driving on a highway, when a vehicle behind quickly overtakes a vehicle, the vehicle is shaken from side to side due to the sudden air pressure change caused by the overtaking vehicle. In severe cases, the vehicle moves laterally regardless of a driver's intention, leading to becoming unstable vehicle behavior.

The larger a size of the overtaking vehicle, the stronger this phenomenon may occur. Upon a large vehicle approaching from behind, a driver should take a defensive stance with a firm grip on the steering wheel and avoid sudden braking or rapid acceleration.

When directly driving a vehicle, a driver may identify and respond to a vehicle approaching at high speed with visual and auditory signals in advance. However, during autonomous driving, such as semi-autonomous driving or fully autonomous driving, the vehicle itself should be able to detect and respond to the vehicle approaching in order to minimize shaking of the vehicle due to the overtaking vehicle.

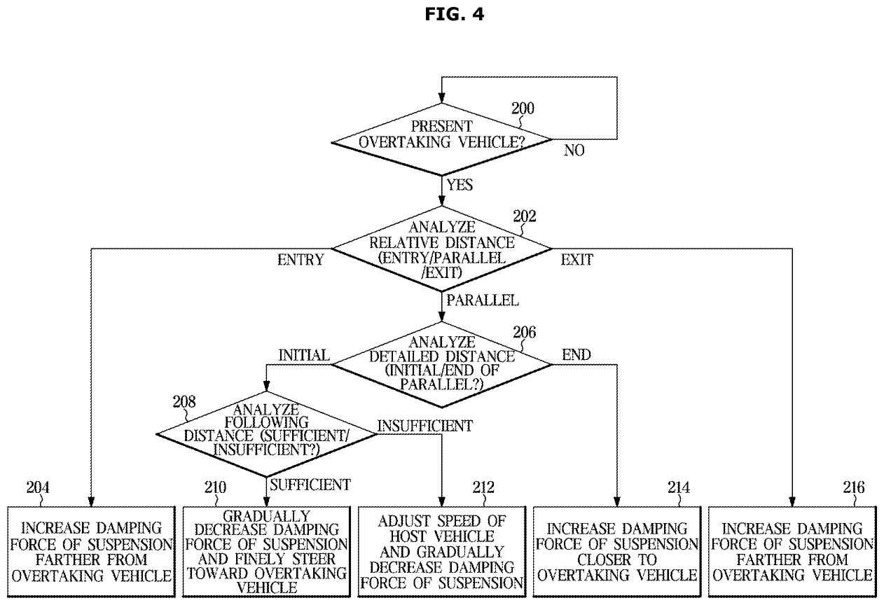

FIG. 4 is a flowchart showing a method for controlling a vehicle.

Referring to FIG. 4, the controller 10 determines whether an overtaking vehicle 2 presents (200).

The control unit 200 determines whether there is a vehicle quickly approaching from behind in a left lane and right lane of the host vehicle 1, and upon determining that there is a vehicle rapidly approaching from the rear left and right sides of the host vehicle 1, may determine that the overtaking vehicle 2 presents.

Upon determining that the overtaking vehicle 2 presents (YES in 200), the controller 10 may analyze the relative distance between the host vehicle 1 and the overtaking vehicle 2 (202).

Based on the result of analyzing the relative distance, the controller 10 may determine whether an overtaking section (e.g., a position relative to the host vehicle 1) of the overtaking vehicle 2 passing the host vehicle 1 corresponds to an entry zone, a parallel zone(passing zone), or an exit zone.

The entry, parallel, and exit zones may consist of continuous sections.

The entry zone is a distance area in which the overtaking vehicle 2 is close to the host vehicle 1. For example, the entry zone may be an area where the overtaking vehicle is starting to overtake the host vehicle and there is no lateral overlap between the host vehicle and the overtaking vehicle (e.g., the frontmost part of the overtaking vehicle falls behind the rearmost part of the host vehicle).

The parallel zone is a distance area in which the overtaking vehicle 2 passes through the host vehicle 1. For example, the parallel zone may be an area where the overtake is in progress, and at least part of the overtaking vehicle laterally overlaps with the host vehicle.

The exit zone is a distance area in which the overtaking vehicle 2 exits the host vehicle 1. For example, the exit zone may be an area where the overtake is finished, and there is no lateral overlap between the host vehicle and the overtaking vehicle (e.g., the rearmost part of the overtaking vehicle is ahead of the frontmost part of the host vehicle).

The exact boundaries of the entry zone, the parallel zone, and the exit zone need not adhere to the examples described above, and each of them may be adjusted (e.g., forward or backward). The zones may be mutually exclusive or may have overlapping areas with each other.

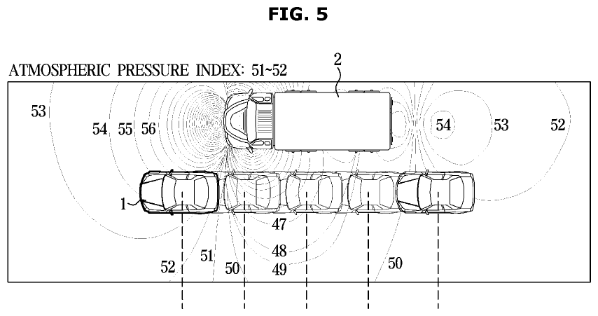

FIG. 5 is a view illustrating a drag difference according to relative positions between a host vehicle and an overtaking vehicle.

Referring to FIG. 5, the overtaking vehicle 2 is subject to air resistance (i.e., drag and lateral force). Drag is the force of air acting in front of the overtaking vehicle 2.

When the overtaking vehicle 2 quickly passes the host vehicle 1 while driving on a highway, the overtaking vehicle 2 pushes through the air quickly, creating a high pressure area in front of the overtaking vehicle 1 and a low pressure area behind thereof.

The air resistance received by the host vehicle 1 varies depending on the relative position of the host vehicle 1 with the overtaking vehicle 2. Therefore, the lateral force and yaw moment acting on the host vehicle 1 change according to the change in the relative position of the host vehicle 1 with the overtaking vehicle 2.

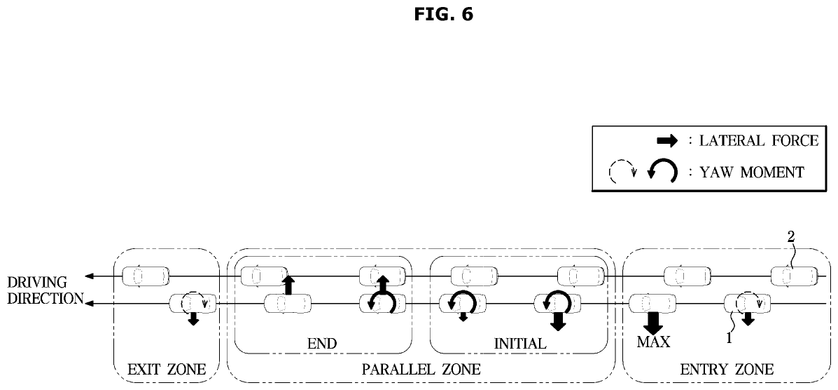

FIG. 6 is a view illustrating lateral force and yaw moment according to relative positions between a host vehicle and an overtaking vehicle.

Referring to FIG. 6, a magnitude and direction of the lateral force and a magnitude and direction of the yaw moment of the host vehicle 1 are shown in the entry zone, parallel zone, and exit zone. A magnitude and direction of the arrow corresponding to the lateral force indicates the magnitude and direction of the lateral force, and a magnitude and direction of the arrow corresponding to the yaw moment indicates the magnitude and direction of the yaw moment.

The entry zone is a section in which the overtaking vehicle 2 enters an area close to the host vehicle 1.

In the entry zone, as the overtaking vehicle 2 approaches the host vehicle 1, the lateral force that pushes the host vehicle 1 in the opposite direction from which the overtaking vehicle 2 enters (left direction of the host vehicle 1 in FIG. 6) increases. Such the lateral force is the force of air acting on the side of the vehicle 1.

The entry zone is a section where the magnitude of the lateral force acting on the host vehicle 1 is greatest compared to the other sections. In the entry zone, the host vehicle 1 may be subject to a clockwise yaw moment.

The parallel zone is a section in which the overtaking vehicle 2 passes through the host vehicle 1.

At the initial of the parallel zone, the lateral force directed to the left of the host vehicle 1 and the yaw moment in the counterclockwise direction act on the host vehicle 1. Accordingly, at the initial of the parallel zone, the host vehicle 1 moves in a direction to be pushed away from the overtaking vehicle 2 (the left direction of the host vehicle 1). In other words, the directions of the lateral force and the yaw moment acting on the host vehicle 1 coincide, so that the host vehicle 1 moves obliquely.

At the end of the parallel zone, the direction of the lateral force acting on the host vehicle 1 changes to the opposite direction (right direction of the host vehicle 1). Accordingly, the lateral force directed to the right of the host vehicle 1 and the yaw moment in the counterclockwise direction act on the host vehicle 1. As a result, the host vehicle 1 moves in a direction approaching the overtaking vehicle 2 (the right direction of the host vehicle 1).

From the initial to the end of the parallel zone, the direction of the lateral force changes from the right side of the vehicle 1 to the left side thereof, and the magnitude of the yaw moment gradually decreases.

The exit zone is a section in which the overtaking vehicle 2 exits from the host vehicle 1.

In the exit zone, the direction of the lateral force acting on the host vehicle 1 is changed once more due to influence of the momentary tailwind of the overtaking vehicle 2. In other words, the direction of the lateral force is again changed to the left direction of the host vehicle 1.

Because the directions of the lateral force and the yaw moment applied to the host vehicle 1 is changed every moment in the entry, parallel, and exit zones, appropriate suspension control and appropriate steering control and/or speed control are required to minimize left and right shaking of the host vehicle.

Referring back to FIG. 4, in response to the overtaking section being the entry zone (ENTRY in 202), the controller 10 may increase the damping force of the suspension farther from the overtaking vehicle 2 (e.g., on the far side of the overtaking vehicle 2) among the suspensions 100 (204).

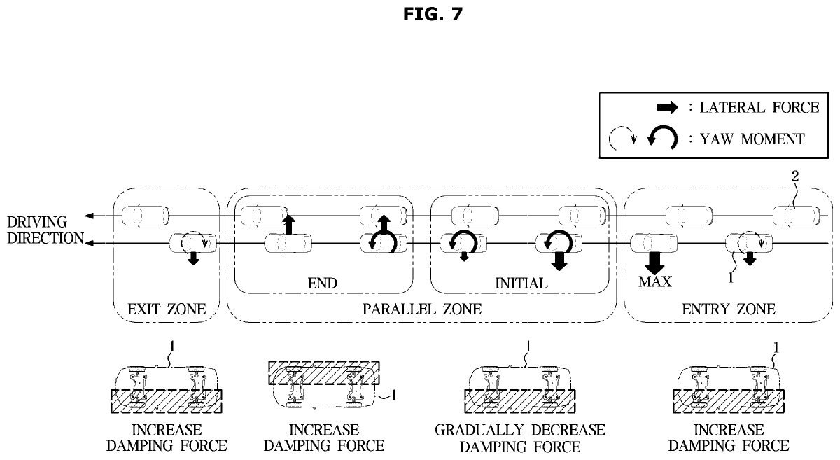

The controller 10 increases the damping force of the FL wheel side suspension and the RL wheel suspension among the four suspensions 100 (see suspension control in the entry zone of FIG. 7).

In the entry zone, the lateral force pushing the host vehicle 1 in the opposite direction from which the overtaking vehicle 2 enters (the left direction of the host vehicle 1) acts on the host vehicle 1, resulting in rolling the host vehicle 1 leftward. The host vehicle 1 maintains a level with a well-balanced left/right balance when driving under normal conditions, while the host vehicle 1 tilts left/right when a strong crosswind or centrifugal force is applied. When any other vehicle quickly overtakes the host vehicle in a side lane, the lateral force due to a pressure difference acts on the host vehicle, thereby occurring to a roll behavior.

Accordingly, among the four suspensions, the damping force of the suspensions farther from the overtaking vehicle 2 (i.e., FL wheel side suspension and RL wheel side suspension) is increased to the maximum value to prevent the host vehicle 1 from rolling.

Furthermore, in response to the overtaking section being the parallel zone (PARALLEL in 202), the controller 10 may analyze a detailed distance between the host vehicle 1 and the overtaking vehicle 2 (206).

The controller 10 may determine, based on the result of analyzing the detailed distance, which one of the initial (e.g., back) of the parallel zone and the end of the parallel zone is corresponded thereto. The back of the parallel zone may be a rear half of the parallel zone.

At the initial of the parallel zone (INITIAL in 206), the controller 10 may analyze a following distance (or a gap) between the host vehicle 1 and the overtaking vehicle 2 (208).

The controller 10 may determine whether the following distance is sufficient or insufficient based on the result of analyzing the following distance. The controller 10 may determine that the following distance is sufficient in response to the following distance being longer than a predetermined distance (e.g., a threshold distance). The controller 10 may determine that the following distance is insufficient in response to the following distance being shorter than the predetermined distance.

If the following distance is sufficient (SUFFICIENT in 208), the controller 10 gradually decreases the damping force of the suspensions (FL wheel side suspension and RL wheel side suspension) whose damping force have increased (see suspension control at the initial of the parallel zone in FIG. 7) and at the same time finely steers the host vehicle 10 toward the overtaking vehicle 2 (210).

Meanwhile, if the following distance is insufficient (INSUFFICIENT in 208), the controller 10 gradually decreases the damping force of the suspensions (FL wheel side suspension and RL wheel side suspension) whose damping force have increased and at the same time adjusts the speed of the host vehicle 10 according to the speed of the overtaking vehicle 2 (212).

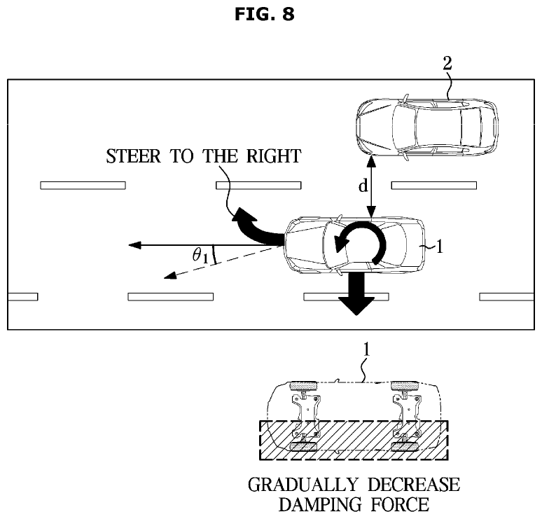

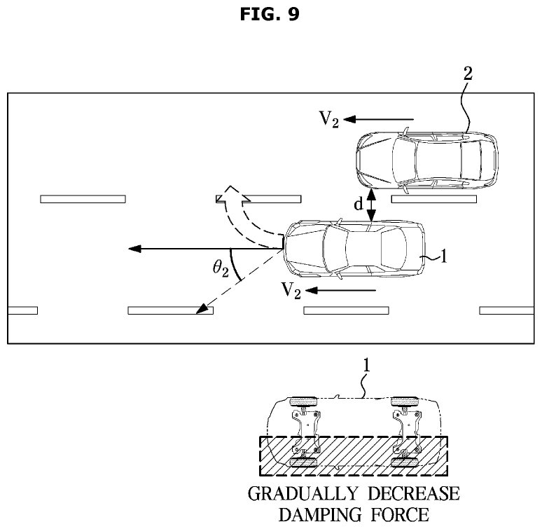

FIG. 8 is a view illustrating suspension control when a following distance between a host vehicle and an overtaking vehicle is sufficient, FIG. 9 is a view illustrating suspension control when a following distance between a host vehicle and an overtaking vehicle is insufficient.

Referring to FIG. 8 and FIG. 9, the direction of the lateral force coincides with the direction of the yaw moment at the initial of the parallel zone, so that the driving direction of the host vehicle 1 is pushed away from the overtaking vehicle 2. Therefore, the host vehicle 1 is not traveling in a straight line, but in a diagonal direction by an angle of θ1, thereby requiring steering assistance (see the solid curved arrow in FIG. 8) along with suspension control.

However, if the overtaking vehicle 2 is a large vehicle with a wide width, the overtaking vehicle 2 drives leaning to one side in the direction of the host vehicle, or the host vehicle 1 drives leaning to one side in the direction of the overtaking vehicle, the following distance d between the host vehicle 1 and the overtaking vehicle 2 is close, so that steering assistance for the host vehicle 1 may be difficult. In other words, when the following distance between the host vehicle 1 and the overtaking vehicle 2 is insufficient, a situation in which steering assistance for the host vehicle 1 is impossible may occur.

The smaller the following distance between the host vehicle 1 and the overtaking vehicle 2 becomes, the greater the lateral force is generated.

Accordingly, when the overtaking vehicle 2 passes close to the host vehicle 1, the host vehicle is subjected to a greater lateral force. The host vehicle 1 does not travel in a straight line and further flows in a diagonal direction by an angle of 82. The smaller the distance between the host vehicle 1 and the overtaking vehicle 2, the greater the lateral force, so that the steering angle for correcting the driving direction of the host vehicle 1 needs to be adjusted more (see the dotted curve arrow in FIG. 9).

However, when steering correction is performed in a situation where the following distance is already narrow, it is difficult to secure a safe distance between the host vehicle 1 and the overtaking vehicle 2. Accordingly, it is important to minimize the magnitude of the lateral force acting on the host vehicle 1 first. Because the lateral force acting on the host vehicle 1 is proportional to the square of the speed difference between the two vehicles (speed of the overtaking vehicle speed—speed of the host vehicle), speed adjustment is required before the steering correction in a situation where the following distance between vehicles is insufficient.

FIG. 9 shows adjusting the speed of the host vehicle to V2, which is the speed of the overtaking vehicle, but it is not limited thereto, and the speed of the host vehicle 1 may be adjusted within a preset speed range of the speed of the overtaking vehicle 2. In other words, the lateral force is reduced by increasing the speed of the host vehicle 1 to a level similar to that of the overtaking vehicle 2 within the preset speed range.

Referring back to FIG. 4, at the end (e.g., front) of the parallel zone (END in 206), the controller 10 may increase the damping force of the suspension closer to the overtaking vehicle 2 among the suspensions 100 (214). The front of the parallel zone may be a front half of the parallel zone.

The controller 10 increases the damping forces of the FR wheel side suspension and the RR wheel side suspension among the four suspensions 100 (see suspension control at the end of the parallel zone in FIG. 7).

At the end of the parallel zone, the lateral force acting on the host vehicle 1 is changed in the opposite direction to that of the initial of the parallel zone, so that a roll behavior in which the host vehicle 1 rolls in the right direction occurs.

Accordingly, the rolling of the host vehicle 1 may be prevented by increasing the damping force of the suspensions closest to the overtaking vehicle 2 (FR wheel side suspension and RR wheel side suspension) among the four suspensions.

Meanwhile, in response to the overtaking section being in the exit zone (exit in 202), the controller 10 may increase the damping force of the suspension farther from the overtaking vehicle 2 among the suspensions 100 (216).

The controller 10 increases the damping force of the FL wheel side suspension and the RL wheel side suspension among the four suspensions 100 (see suspension control in the exit zone of FIG. 7).

In the exit zone, the lateral force acting on the host vehicle 1 is changed once again in the opposite direction to the end of the parallel zone, so that a roll behavior in which the host vehicle 1 rolls in the left direction occurs.

Accordingly, the rolling of the host vehicle 1 may be prevented by increasing the damping force of the suspension farther from the overtaking vehicle 2 (the FL wheel side suspension and the RL wheel side suspension) among the four suspensions.

Hereinafter, suspension adjustment according to a body type of the host vehicle 1 and an overall height of the overtaking vehicle 2 will be described.

A difference in lateral force applied to the host vehicle 1 may exist depending on the body type of the host vehicle 1 and the overall height of the overtaking vehicle 2. The magnitude of the lateral force is predictable.

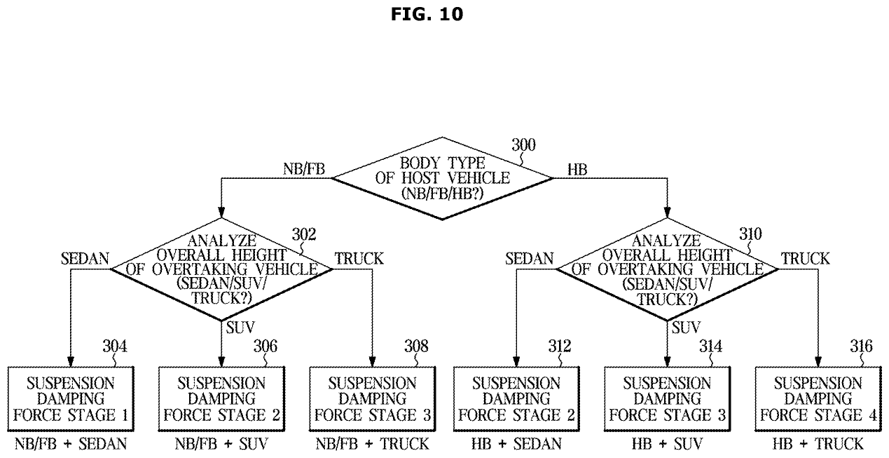

FIG. 10 is a view illustrating a suspension control according to a body type of a host vehicle and an overall height of an overtaking vehicle.

Referring to FIG. 10, the controller 10 may determine the body type of the host vehicle 1 (300).

The body type of the host vehicle 1 may include a notchback (NB), a fastback (FB), and a hatchback (HB). In general, a NB, a FB, and a HB are classified based on the rear shape of a vehicle.

If the body type of the host vehicle 1 corresponds to a NB or a FB, the controller 10 may analyze the overall height of the overtaking vehicle 2 (302).

The controller 10 may determine, based on a result of analyzing the overall height of the overtaking vehicle 2, whether the overall height of the overtaking vehicle 2 corresponds to any one of a sedan, a sport utility vehicle (SUV), or a truck.

If the overall height of the overtaking vehicle 2 corresponds to a sedan, the controller 10 determines the damping force of the suspension 100 as stage 1 (304).

If the overall height of the overtaking vehicle 2 corresponds to an SUV, the controller 10 determines the damping force of the suspension 100 as stage 2 (306).

If the overall height of the overtaking vehicle 2 corresponds to a truck, the controller 10 determines the damping force of the suspension 100 as stage 3 (308).

Meanwhile, upon determining that the body type of the host vehicle 1 is a HB, the controller 10 may analyze the overall height of the overtaking vehicle 2 (310). The controller 10 may determine, based on a result of analyzing the overall height of the overtaking vehicle 2, whether the overall height of the overtaking vehicle 2 corresponds to any one of a sedan, an SUV, or a truck.

If the overall height of the overtaking vehicle 2 corresponds to a sedan, the controller 10 determines the damping force of the suspension 100 as stage 2 (312).

If the overall height of the overtaking vehicle 2 corresponds to an SUV, the controller 10 determines the damping force of the suspension 100 as stage 3 (314).

If the overall height of the overtaking vehicle 2 corresponds to a truck, the controller 10 determines the damping force of the suspension 100 as stage 4 (316).

Then, the controller 10 controls the suspension in the overtaking section by applying the damping force of the determined stage.

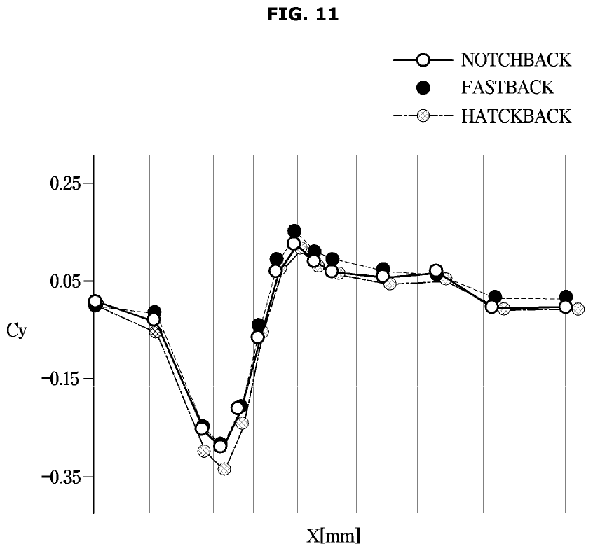

FIG. 11 is a graph showing lateral force for each body type of a vehicle.

Referring to FIG. 11, it can be seen that the magnitude of the lateral force acting on the host vehicle 1 also varies according to the body type of the host vehicle 1.

It can be seen that a NB and a FB have similar the magnitudes of lateral force, while a HB has a lateral force larger than that of the NB and FB.

Accordingly, damping force adjustment of the suspension needs to be changed based on the body type of the host vehicle 1.

Under the same condition (e.g., speed difference/following distance), the lateral force in the case where the body type of the host vehicle 1 corresponds to a HB is greater than that in the case of a NB and a FB, so that the damping force of the suspension of the host vehicle 1 is adjusted to be larger. For example, the damping force of the suspension in the case of HB (e.g., SUV) is changed to a larger value than that in the case of a NB and a FB (e.g., sedan).

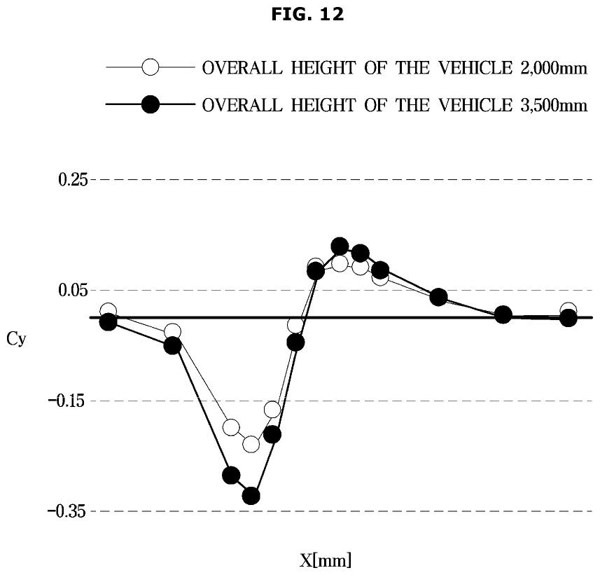

FIG. 12 is a graph showing a lateral force applied to a host vehicle according to an overall height of an overtaking vehicle.

Referring to FIG. 12, when the overtaking vehicle 2 passes by while pushing air at high speed, a high pressure area is formed on the front side of the overtaking vehicle 2 and a low pressure area is formed on the rear side of the overtaking vehicle 2.

The size of the high pressure/low pressure areas is determined by the overall height of the overtaking vehicle 2, and the higher the overall height of the vehicle the greater the lateral force during overtaking.

It can be seen that a vehicle with an overall height of 3,500 mm has a higher lateral force than a vehicle with an overall height of 2,000 mm. In other words, it can be understood that the higher the overall height of the overtaking vehicle 2, the greater the lateral force acting on the host vehicle 1.

Accordingly, the damping force adjustment of the suspension according to the overall height of the overtaking vehicle 2 is required.

Under the same speed difference/following distance condition, the lateral force in the case where the overall height of the overtaking vehicle 2 corresponds to a truck (or bus) is greater than that in the case where the overall height of the overtaking vehicle 2 corresponds to a sedan, so that the damping force of the suspension of the host vehicle is adjusted to be larger. For example, the damping force of the suspension in the case where the overtaking vehicle 2 is a truck is changed to a larger value than the damping force of the suspension in the case where the overtaking vehicle 2 is a sedan.

As such, when the body type of the host vehicle 1 is a NB or a FB, the damping force of the suspension is determined as stage 1 in response to the overall height of the overtaking vehicle being a sedan, the damping force of the suspension is determined as stage 2 in response to the overall height of the overtaking vehicle being a SUV, the damping force of the suspension is determined as stage 3 in response to the overall height of the overtaking vehicle being a truck. The higher the overall height, the higher the damping force of the suspension. In other words, the damping force of the suspension may have a positive correlation with respect to the overall height of the overtaking vehicle.

Meanwhile, when the body type of the host vehicle 1 is a HB, the damping force of the suspension is determined as stage 2 in response to the overall height of the overtaking vehicle being a sedan, the damping force of the suspension is determined as stage 3 in response to the overall height of the overtaking vehicle being a SUV, the damping force of the suspension is determined as stage 4 in response to the overall height of the overtaking vehicle being a truck. As the overall height increases, the damping force of the suspension is increased by one stage more than when the body type of the host vehicle 1 is a NB or a FB.

As described above, the present disclosure may predict the left and right shaking of the host vehicle due to the surrounding vehicles approaching the host vehicle, and minimize the left and right shaking of the host vehicle by using the suspension control, thereby improving ride comfort and straight-line driving stability of the vehicle. Furthermore, the present disclosure may further improve the riding comfort and straight-line driving stability of the vehicle through steering control and/or speed control together with suspension control.

On the other hand, the above-described examples may be implemented in the form of a recording medium storing instructions executable by one or more processors of a computer or any other computing devices. The instructions may be stored in the form of program code. When the instructions are executed by a processor, a program module is generated by the instructions so that the operations of the disclosed embodiments may be carried out. The recording medium may be implemented as a computer-readable recording medium.

The computer-readable recording medium includes all types of recording media storing data readable by a computer system. Examples of the computer-readable recording medium include a Read Only Memory (ROM), a Random Access Memory (RAM), a magnetic tape, a magnetic disk, a flash memory, an optical data storage device, or the like.

Although various examples of the disclosure have been shown and described, it would be appreciated by those having ordinary skill in the art that changes may be made in the example(s) described herein without departing from the principles and spirit of the disclosure, the scope of which is defined in the claims and their equivalents.

What is claimed is:

1. A host vehicle comprising:
a camera having a surrounding field of view of the host vehicle and configured to obtain image data;
a plurality of suspensions, wherein each suspension of the plurality of suspensions is provided at a corresponding wheel of the host vehicle; and
a controller electrically connected to the plurality of suspensions and comprising:
one or more processors; and
memory storing instructions that, when executed by the one or more processors, cause the controller to:
determine, based on the image data, a position, relative to the host vehicle, of an overtaking vehicle overtaking the host vehicle; and
control, based on the position of the overtaking vehicle, a damping force of at least one of the plurality of suspensions.

2. The host vehicle of claim 1, wherein the position comprises one of an entry zone, a parallel zone, or an exit zone.

3. The host vehicle of claim 2, wherein the at least one of the plurality of suspensions corresponds to one of the entry zone, the parallel zone, or the exit zone.

4. The host vehicle of claim 2, wherein the instructions, when executed by the one or more processors, cause the controller to control the damping force of the at least one of the plurality of suspensions by increasing, based on the position of the overtaking vehicle being the entry zone, a damping force of one or more suspensions, of the host vehicle, on a far side of the host vehicle relative to the overtaking vehicle.

5. The host vehicle of claim 2, wherein the instructions, when executed by the one or more processors, cause the controller to control the damping force of the at least one of the plurality of suspensions by gradually reducing, based on the position of the overtaking vehicle being at a back of the parallel zone, a damping force of one or more suspension, of the host vehicle, on a far side of the host vehicle relative to the overtaking vehicle.

6. The host vehicle of claim 2, wherein the instructions, when executed by the one or more processors, cause the controller to control the damping force of the at least one of the plurality of suspensions by performing, based on the position of the overtaking vehicle being at a back of the parallel zone and further based on a following distance between the host vehicle and the overtaking vehicle, a steering control or speed control of the host vehicle.

7. The host vehicle of claim 6, wherein the instructions, when executed by the one or more processors, further cause the controller to, based on the following distance being greater than a threshold distance, steer the host vehicle toward the overtaking vehicle.

8. The host vehicle of claim 6, wherein the instructions, when executed by the one or more processors, further cause the controller to, based on the following distance being less than or equal to a threshold distance, increase a speed of the host vehicle within a preset speed range relative to a speed of the overtaking vehicle.

9. The host vehicle of claim 2, wherein the instructions, when executed by the one or more processors, cause the controller to control the damping force of the at least one of the plurality of suspensions by increasing, based on the position of the overtaking vehicle being at a front of the parallel zone, a damping force of one or more suspensions, of the host vehicle, on a near side of the host vehicle relative to the overtaking vehicle.

10. The host vehicle of claim 2, wherein the instructions, when executed by the one or more processors, cause the controller to control the damping force of the at least one of the plurality of suspensions by increasing, based on the position of the overtaking vehicle being at the exit zone, a damping force of one or more suspensions, of the host vehicle, on a far side of the host vehicle relative to the overtaking vehicle.

11. The host vehicle of claim 1, wherein the instructions, when executed by the one or more processors, cause the controller to control the damping force of the at least one of the plurality of suspensions by adjusting the damping force of the at least one of the plurality of suspensions based on at least one of: a body type of the host vehicle, or an overall height of the overtaking vehicle.

12. The host vehicle of claim 11, wherein the body type of the host vehicle comprises at least one of: a notchback type, a fastback type, or a hatchback type.

13. The host vehicle of claim 12, wherein the instructions, when executed by the one or more processors, cause the controller to control the damping force of the at least one of the plurality of suspensions by controlling, based on the body type of the host vehicle being the hatchback type, the damping force of the at least one of the plurality of suspensions to be higher than for the notchback type and for the fastback type.

14. The host vehicle of claim 11, wherein the damping force of the at least one of the plurality of suspensions has a positive correlation with respect to the overall height of the overtaking vehicle.

15. A method comprising:
obtaining, via a camera, image data on surroundings of a host vehicle;
determining, by one or more processors and based on the image data, a position, relative to the host vehicle, of an overtaking vehicle overtaking the host vehicle; and
controlling, by the one or more processors and based on the position of the overtaking vehicle, a damping force of at least one of a plurality of suspensions of the host vehicle, wherein each suspension of the plurality of suspensions is provided at a corresponding wheel of the host vehicle.

16. The method of claim 15, wherein the position comprises one of an entry zone, a parallel zone, or an exit zone.

17. The method of claim 16, wherein the controlling of the damping force of the at least one of the plurality of suspensions comprises:
based on the position being one of the entry zone or the exit zone, increasing a damping force of one or more suspensions, of the host vehicle, on a far side of the host vehicle relative to the overtaking vehicle.

18. The method of claim 16, wherein the controlling of the damping force of the at least one of the plurality of suspensions comprises, based on the position of the overtaking vehicle being at a back of the parallel zone:
gradually reducing a damping force of one or more suspensions, of the host vehicle, on a far side of the host vehicle relative to the overtaking vehicle; and
performing, further based on a following distance between the host vehicle and the overtaking vehicle, a steering control or speed control of the host vehicle.

19. The method of claim 15, wherein the controlling of the damping force of the at least one of the plurality of suspensions comprises:
adjusting the damping force of the at least one of the plurality of suspensions based on at least one of: a body type of the host vehicle, or an overall height of the overtaking vehicle.

20. The method of claim 19, wherein the body type of the host vehicle comprises at least one of: a notchback type, a fastback type, or a hatchback type, and
wherein the controlling of the damping force of the at least one of the plurality of suspensions comprises:
controlling, based on the body type of the host vehicle being the hatchback type, the damping force of the at least one of the plurality of suspensions to be higher than for the notchback type and for the fastback type.
